(19) United States
(12) Patent Application Publication
(10) Pub. No.: US 2003/0010009 A1
(43) Pub. Date: Jan. 16, 2003

(54) Cutting apparatus and guard assembly for a chain cutter

(76) Inventors: Donald W. Bickel, Peru, IL (US); Dennis J. Jones, Mendota, IL (US)

Correspondence Address: MICHAEL BEST & FRIEDRICH, LLP, 100 E WISCONSIN AVENUE, MILWAUKEE, WI, 53202, US

(21) Appl. No.: 10/195,037

(22) Filed: Jul. 12, 2002

Related U.S. Application Data
(60) Provisional application No. 60/305,784, filed on Jul. 16, 2001.

(51) Int. Cl. A01D 34/83

(52) U.S. Cl. 56/244

(57) ABSTRACT

A cutting apparatus, a guard assembly for a cutting apparatus and a method of assembling a cutting apparatus. The cutting apparatus includes a frame supported for movement over ground, the frame having a forward portion, a cutter support supported on the forward portion, and a cutting assembly. The cutting assembly includes a chain cutter assembly and a guard assembly. The chain cutter assembly includes a continuous chain assembly having opposite lateral chain surfaces, a plurality of knife members connected to the chain assembly to form a cutting portion, and a drive assembly for driving the chain assembly. In some aspects, the guard assembly includes a guard supported by the cutter support, the guard defining a channel having opposite lateral channel surfaces engageable with the opposite lateral chain surfaces to guide a portion of the chain assembly in the channel. In some aspects, the guard assembly includes a first guard section supportable by the cutter support, and a second guard section supportable by the cutter support, the first guard section and the second guard section cooperating to support a portion of the chain cutter assembly, the first guard section being supported adjacent the second guard section at a joint, the joint being oriented at a non-perpendicular angle relative to the channel.

### FIELD OF THE INVENTION

The present invention relates to cutting apparatus and, more particularly, to a guard assembly for a chain cutter assembly.

### BACKGROUND OF THE INVENTION

A typical cutting apparatus, such as a mowing apparatus or a harvester, includes a frame supported for movement over ground, the frame having a forward portion, and a cutter support supported on the forward portion of the frame. Some cutting apparatus include a reciprocating cutting assembly supported by the cutter support. Some other cutting apparatus include a chain sickle cutter assembly supported by the cutter support.

### SUMMARY OF THE INVENTION

One independent problem with some cutting apparatus including a chain sickle cutter assembly is that the guard cooperates with the cutter support to define a channel to guide and support the chain of the cutter assembly. Because of this cooperation in providing a guide channel, close manufacturing and assembly tolerances are required between the guard and the cutter support, increasing the cost of manufacture and operation of the cutter assembly. If the guide channel is not precisely constructed, the chain can kink causing the cutter assembly to lock up. In addition, the guard and the cutter support may be constructed of different materials having different characteristics, such as, for example, coefficient of friction, which may affect the operation and durability of the cutter assembly.

Another independent problem with some other cutting apparatus including a chain sickle cutter assembly is that a specialized cutter support is required to support the chain sickle cutter assembly on the cutting apparatus. Such a specialized cutting support defines the channel to guide and support a portion of the chain and must replace the cutter support of the existing cutting apparatus.

Yet another independent problem with some cutting apparatus including a chain sickle cutter assembly is that the channel supports only a portion of the chain assembly. As a result, in the unsupported cutting portion, the chain may kink causing the cutter assembly to lock up. Also, a knife member may not lead properly into the subsequent guard also causing the chain to lock up. In addition, crop material may be pulled into the area between guards and between the guard and the chain sickle cutter assembly, increasing the power required to drive the chain and eventually stalling or locking up the chain.

Another independent problem with some cutting apparatus is that the guard assembly does not allow adequate clearance for the fasteners which connect the knives and the chain members of the cutter assembly, resulting in contact between the fasteners and the guard. Such contact can cause the fastener and the cutter assembly to be loosened and can cause wear on the apparatus.

The present invention provides a cutting apparatus and a guard assembly for a chain cutter assembly which substantially alleviates one or more of these and other independent problems with the above-described cutting apparatus. In some aspects of the invention, the cutting apparatus includes a guard assembly defining a channel having opposite lateral channel surfaces to guide a portion of the chain assembly in the channel. In some aspects of the invention, the channel extends along the length of the cutting portion of the chain cutter assembly. In some aspects of the invention, the guard assembly includes a first guard section supported adjacent a second guard section at a joint, the joint being oriented at a non-perpendicular angle relative to the channel. In some aspects of the invention, the chain cutter assembly is substitutable for another cutting assembly, such as a reciprocating cutter assembly, on an existing cutting apparatus.

More particularly, the present invention provides a cutting apparatus comprising a frame supported for movement over ground, the frame having a forward portion, a cutter support supported on the forward portion, and a cutting assembly. The cutting assembly is defined as including a chain cutter assembly and a guard assembly. The chain cutter assembly is defined as including a continuous chain assembly having opposite lateral chain surfaces, a plurality of knife members connected to the chain assembly to form a cutting portion, and a drive assembly for driving the chain assembly. The guard assembly is defined as including a guard supported by the cutter support, the guard defining a channel having opposite lateral channel surfaces engageable with the opposite lateral chain surfaces to guide a portion of the chain assembly in the channel.

Preferably, the cutting apparatus further comprises a second cutting assembly selectively supportable by the cutter support. The second cutting assembly is defined as including a reciprocating cutter assembly including a cutter bar supported for reciprocating movement, a plurality of knives supported by the cutter bar, and a reciprocating drive assembly operable to reciprocate the cutter bar. The reciprocating cutter assembly also includes a reciprocating cutter guard assembly including a reciprocating cutter guard member selectively supported by the cutter support. Preferably, the first-mentioned cutting assembly is substitutable for the second cutting assembly.

Each of the plurality of knife members has a knife upper surface and a knife lower surface, and the guard assembly preferably includes a first guard positioned adjacent the knife lower surface and a second guard positioned adjacent the knife upper surface, one of the first guard and the second guard defining the channel. In some constructions, the first guard defines the channel. The channel may include a lower surface extending between the opposite lateral surfaces. In some other constructions, the second guard defines the channel. The channel may include an upper channel surface extending between the opposite lateral channel surfaces.

The guard may be positioned adjacent the knife lower surface and may include a guard upper surface engaging the knife lower surface to support selected ones of the plurality of knife members. The cutting portion has a length, and the guard upper surface preferably engages the knife lower surface of the plurality of knife members in the cutting portion along the length of the cutting portion. Preferably, the channel extends along the length of the cutting portion. The guard assembly may include a first guard positioned adjacent the lower knife surface and a second guard positioned adjacent the knife upper surface, the second guard having a guard lower surface engageable with a portion of the knife upper surface.

The chain cutter assembly may include fastener members extending generally vertically and connecting the plurality of knife members and chain members to form the chain assembly, each fastener member having a fastener end. The guard may have a channel surface extending between the opposite lateral channel surfaces, the channel surface and the opposite lateral channel surfaces preferably being spaced from the fastener end.

The guard assembly may include a first guard section and a second guard section cooperating to define the channel, the first guard section being supported adjacent the second guard section at a joint. Preferably, the joint is oriented at a non-perpendicular angle relative to the channel. The joint may be oriented at an angle of approximately 45° relative to a vertical plane.

The guard assembly may include a first guard positioned adjacent the lower knife surface and a second guard positioned adjacent the knife upper surface. The first guard may be provided by a first lower guard section positioned adjacent a second lower guard section at a lower joint, and the second guard may be provided by a first upper guard section positioned adjacent a second upper guard section at an upper joint. Preferably, the lower joint and the upper joint are each oriented at a non-perpendicular angle relative to the channel. Preferably, the lower joint is oriented at a different angle than the upper joint. Also, the lower joint is preferably laterally offset from the upper joint.

Also, the present invention provides a cutting apparatus comprising a frame supported for movement over ground, the frame having a forward portion, a cutter support supported on the forward portion of the frame, and a cutting assembly. The cutting assembly is defined as including a chain cutter assembly including a continuous chain assembly, a plurality of knives connected to the chain assembly to form a cutting portion, and a drive assembly for driving the chain assembly. The cutting assembly is defined as further including a guard assembly including a first guard section and a second guard section supported by the cutter support, the first guard section and the second guard section cooperating to define a portion of a channel to support a portion of the chain cutter assembly, the first guard section being supported adjacent the second guard section at a joint, the joint being oriented at a non-perpendicular angle relative to the channel.

In addition, the present invention provides a guard assembly for a cutting apparatus, the cutting apparatus including a frame supported for movement over ground, the frame having a forward portion, a cutter support supported on the forward portion of the frame, and a chain cutter assembly including a continuous chain assembly having opposite lateral chain surfaces, a plurality of knife members connected to the chain assembly to form a cutting portion, and a drive assembly for driving the chain assembly. The guard assembly is defined as comprising a guard defining a channel having opposite lateral channel surfaces engageable with the opposite lateral chain surfaces to guide a portion of the chain assembly in the channel, and a fastener selectively fastening the guard to the cutter support.

Further, the present invention provides a guard assembly for a cutting apparatus, the cutting apparatus including a frame supported for movement over ground, the frame having a forward portion, a cutter support supported on the forward portion of the frame, and a chain cutter assembly including a continuous chain assembly, a plurality of knives connected to the chain assembly to form a cutting portion, and a drive assembly for driving the chain assembly. The guard assembly is defined as comprising a first guard section supportable by the cutter support, and a second guard section supportable by the cutter support, the first guard section and the second guard section cooperating to define a portion of a channel to support a portion of the chain cutter assembly, the first guard section being supported adjacent the second guard section at ajoint, the joint being oriented at a non-perpendicular angle relative to the channel.

Also, the present invention provides a method for assembling a cutting apparatus. The method is defined as comprising the acts of providing a frame supported for movement over ground, the frame having a forward portion, and a cutter support supported on the forward portion of the frame, providing a chain cutter assembly including a continuous chain assembly having opposite lateral chain surfaces, a plurality of knife members connected to the chain assembly to form a cutting portion, and a drive assembly for driving the chain assembly, and providing a guard assembly including a guard defining a channel having opposite lateral channel surfaces. The method is defined as further comprising the acts of supporting the guard on the cutter support, and supporting a portion of the chain assembly with the guard such that the opposite lateral channel surfaces engage the opposite lateral chain surfaces of the portion of the chain assembly to guide the portion of the chain assembly in the channel.

In addition, the present invention provides a method for assembling a cutting apparatus. The method is defined as comprising the acts of providing a frame supported for movement over ground, the frame having a forward portion, and a cutter support supported on the forward portion of the frame, providing a chain cutter assembly including a continuous chain assembly, a plurality of knives connected to the chain assembly to form a cutting portion, and a drive assembly for driving the chain assembly, and providing a guard assembly including a first guard section and a second guard section cooperating to define a portion of a channel. The method is defined as further comprising the acts of supporting the first guard section and the second guard section on the cutter support, the first guard section being supported adjacent the second guard section at a joint, the joint being oriented at a non-perpendicular angle relative to the channel, and supporting a portion of the chain cutter assembly with the guard assembly.

One independent advantage of the present invention is that the guard assembly defines the channel for the chain assembly. Because the guard assembly does not cooperate with the cutter support to define the channel, the manufacture and assembly of the cutting assembly is less expensive and less difficult. The guide channel has a more precise construction, preventing the chain assembly from kinking.

Another independent advantage of the present invention is that the cutting assembly including the chain cutter assembly and the guard assembly is retrofittable and substitutable for a cutting assembly on existing cutting apparatus. A specialized cutter support is not required to support the chain cutter assembly on the cutting apparatus

Yet another independent advantage of the present invention is that the guard assembly and the channel support and guide the chain assembly and the knife members along the length of the cutting portion. This prevents the chain assembly from kinking and locking up. This also insures that each knife member leads properly into the subsequent guard section so that the chain assembly does not lock up. Also, the extended portion of the channel prevents crop material from being pulled in between the chain assembly and the guard assembly.

Yet another independent advantage of the present invention is that the guard assembly prevents vertical movement of the chain assembly and the knife members by constraining the allowed movement of the chain assembly and of each knife member.

A further independent advantage of the present invention is that the guard assembly allows adequate clearance for the fastener members which connect the knives and the chain members of the cutter assembly so that the fastener members do not contact the guard.

Another independent advantage of the present invention is that there is an angled joint between adjacent guard sections. This improves the guidance and support of the knives and the chain assembly as the knife members and chain assembly pass from one guard section to the subsequent guard section. This also prevents crop material from being pulled in between the chain assembly and the guard assembly.

Other independent features and independent advantages of the present invention will become apparent to those skilled in the art upon review of the following detailed description, claims and drawings.

### BRIEF DESCRIPTION OF THE DRAWINGS

FIG. 1 is a partial cross-sectional side view of a portion of a cutting apparatus including a guard assembly embodying the present invention.

FIG. 2 is a bottom perspective view of a portion of the cutting apparatus.

FIG. 3 is a top perspective view of a portion of the cutting apparatus.

FIG. 4 is a front view of a portion of the cutting apparatus.

FIG. 5 is a partial cross-sectional left side view of a first alternative construction of a cutting apparatus and a guard assembly.

FIG. 6 is a partial cross-sectional right side view of the cutting apparatus shown in FIG. 5.

FIG. 7 is a bottom perspective view of the cutting apparatus shown in FIG. 5.

FIG. 8 is a bottom view of the cutting apparatus shown in FIG. 5.

FIG. 9 is a top perspective view of the cutting apparatus shown in FIG. 5.

FIG. 10 is another top perspective view of the cutting apparatus shown in FIG. 5.

FIG. 11 is a top view of the cutting apparatus shown in FIG. 5.

FIG. 12 is a front view of the cutting apparatus shown in FIG. 5.

FIGS. 13-17 are views of the lower guard of the guard assembly shown in FIG. 5.

FIGS. 18-21 are views of the upper guard of the guard assembly shown in FIG. 5.

FIG. 22 is a partial cross-sectional view of a second alternative construction of a cutting apparatus and a guard assembly.

FIG. 23 is a partial cross-sectional side view of a third alternative construction of a cutting apparatus and a guard assembly.

FIG. 24 is a side view of a fourth alternative construction of a cutting apparatus and a guard assembly.

FIG. 25 is a top perspective view of the cutting apparatus shown in FIG. 24.

FIG. 26 is a top view of the cutting apparatus shown in FIG. 24.

FIG. 27 is a front view of the cutting apparatus shown in FIG. 24.

FIGS. 28-31 are views of the lower guard of the guard assembly shown in FIG. 24.

FIGS. 32-35 are views of the upper guard of the guard assembly shown in FIG. 24.

FIG. 36 is a side view of a fifth alternative construction of a portion of a guard assembly.

FIG. 37 is a top perspective view of the portion of the guard assembly shown in FIG. 37.

FIG. 38 is a partial cross-sectional view taken generally along line 38--38 in FIG. 36.

Before one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION OF THE PREFERRED EMBODIMENT

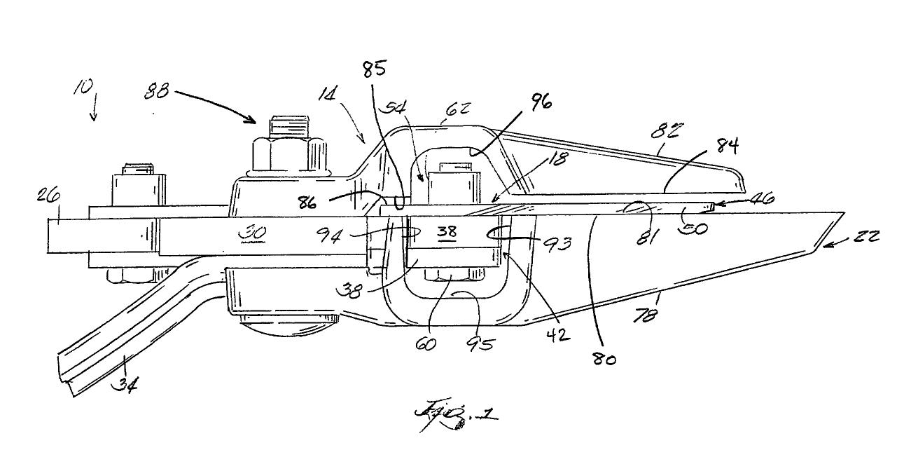

A cutting apparatus 10, such as a mowing apparatus or a harvester, including a cutting assembly 14 is partially illustrated in FIG. 1. The cutting assembly 14 includes a chain sickle cutter assembly 18 and a guard assembly 22 embodying the invention. The cutting apparatus 10 includes a frame 26 supported for movement over ground in a direction and having a forward portion. A cutter support or cutter bar 30 is supported on the forward portion of the frame 26 and extends across the width of the frame 26 and generally transverse to the direction of movement. A skid plate 34 is connected to the cutter bar 30.

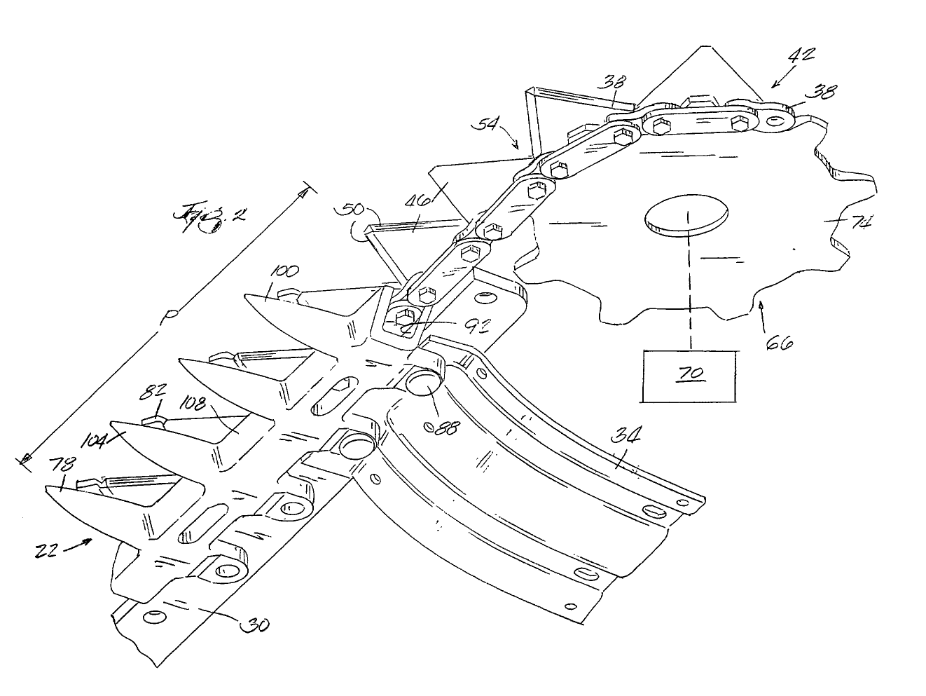

As shown in FIGS. 1-4, the cutter assembly 18 is preferably a chain sickle cutter assembly, such as that disclosed in U.S. Pat. No. 5,732,539, which is hereby incorporated by reference. In the illustrated construction, the cutter assembly 18 includes a plurality of chain members 38 connected to form (see FIG. 2) a continuous chain assembly 42 having (see FIG. 1) opposite lateral chain surfaces. The cutter assembly 18 also includes a plurality of knife members 46 connected to the chain assembly 42 to form a cutting portion P. Each knife member 46 has opposite cutting edges 50. A fastener assembly 54, including a bolt 60 and a nut 62, connects the knife members 46 and the chain members 38 to form the cutter assembly 18. In the illustrated construction, the chain assembly 42 is connected below the knife members 46 to provide a bottom-chain cutter assembly 18.

The cutter assembly 18 also includes (see FIGS. 2-4) a drive assembly 66 for driving the chain assembly 42. The drive assembly 66 includes a drive 70 (schematically illustrated in FIG. 2), such as a motor or a gearbox, driving a rotatable drive sprocket 74. The drive sprocket 74 drivingly engages the chain assembly 42 to rotatably drive the chain assembly 42.

As shown in FIG. 1, the guard assembly 22 includes a lower guard 78 positioned adjacent the lower surface of the knife members 46 and having cutting edges 80 cooperating with the cutting edges 50 on the knife members 46. The lower guard 78 includes a guard upper surface 81 which is engageable with the knife lower surface to support the knife members 46.

The guard assembly 22 also includes an upper guard 82 positioned adjacent the upper surface of the knife members 46 and having cutting edges 84 cooperating with the cutting edges 50 on the knife members 46. In the illustrated construction, the upper guard 82 has a lower guard surface 85 which engages a portion 86 of the knife upper surface to provide a “hold-down” feature, preventing vertical movement and tipping of the chain assembly 42 by constraining the allowed movement of each knife member 46.

It should be understood that, in some constructions (not shown) and for some aspects of the invention, only one guard, such as the guard 78, may be provided. In such a construction, an upper “hold down” feature, such as that provided by the lower guard surface 85 of the upper guard 82, may be provided. It should also be understood that, in some constructions (not shown), only one guard 78 or 82 may include cutting edges 80 or 84, or the guards 78 and 82 may not include cutting edges.

Fasteners 88 connect the guard assembly 22 to the cutter bar 30 to support the guard assembly 22 on the cutter bar 30. The fasteners 88 may be the same as those used to connect the guard assembly (not shown) of another cutting assembly, such as a reciprocating cutter assembly (not shown), to the cutter bar 30. Exemplary reciprocating cutter assemblies are shown in U.S. Pat. Nos. 5,694,754 and 5,241,811, which are hereby incorporated by reference.

In the illustrated construction and in some aspects of the invention, the guard assembly 22 defines a channel 92 for guiding and supporting a portion of the chain assembly 42. In the construction illustrated in FIG. 1, the channel 92 is defined by the lower guard 78 and includes a front wall or front channel surface 93 laterally spaced from a rear wall or rear channel surface 94. The opposite lateral channel surfaces 93 and 94 are engageable with the opposite lateral chain surfaces to guide a portion of the chain assembly 42 in the channel 92.

A lower channel surface 95 extends between the opposite lateral channel surfaces, and the lower channel surface 95 and the opposite lateral channel surfaces 93 and 94 are spaced from the lower end of the fastener assembly 54. The upper guard 82 defines a space or clearance 96 which is spaced from the upper end of the fastener assembly 54. As shown in FIG. 1, adequate clearance is provided between the fastener assemblies 54 and the guards 78 and 82 to prevent contact between the fastener assemblies 54 and the guards 78 and 82.

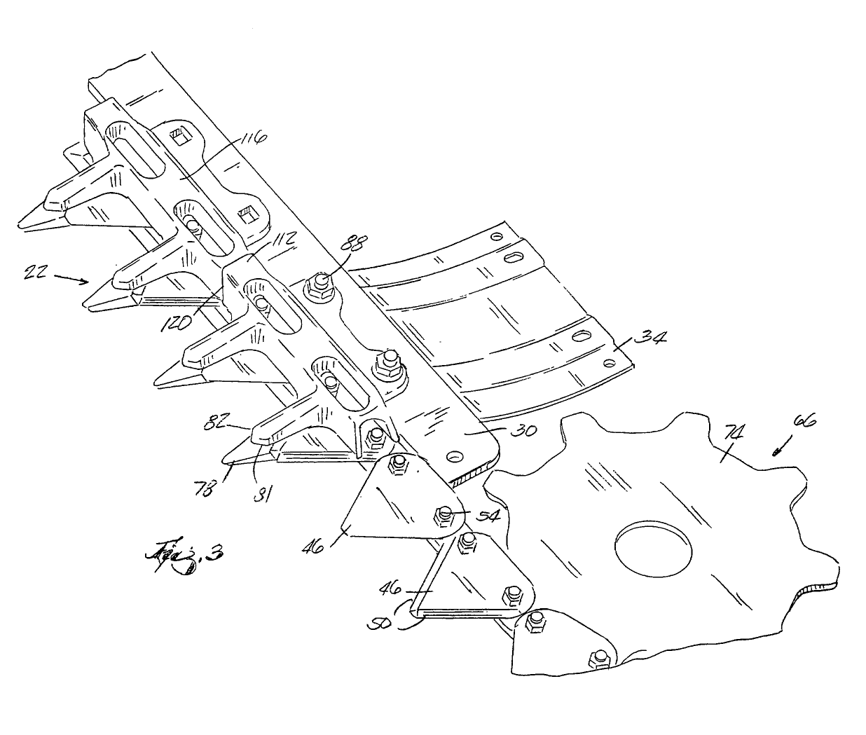

As shown in FIG. 4, in the illustrated construction and in some aspects of the invention, the lower guard 78 is provided by a first lower guard section 100 and a second lower guard sections 104. The lower guard sections 100 and 104 are positioned adjacent to one another at a lower joint 108. The lower joint 108 is oriented at a non-perpendicular angle relative to the channel 92 and relative to the direction of movement of the chain assembly 42. Preferably, the lower joint 108 is oriented at a positive 45° angle (in a clockwise direction in FIG. 4) relative to a vertical plane.

Similarly, in the illustrated construction and in some aspects of the invention, the upper guard 82 is provided by a first upper guard section 112 and a second upper guard section 116. The upper guard sections 112 and 116 are positioned adjacent to each other at an upper joint 120. The upper joint 120 is also preferably oriented at a non-perpendicular angle (i.e., a negative 45° angle (in a counterclockwise direction in FIG. 4)) relative to the channel 92. As shown in FIG. 4, the joints 108 and 120 are preferably laterally offset with respect to one another. Also, the joints 108 and 120 are preferably oriented at a different angle from one another so that a single continuous joint is not provided. The angled joints 108 and 120 prevent crop material from being caught in the joints 108 and 120 and from being pulled into the guard assembly 22. The lateral offset of the joints 108 and 120 also prevents crop material from being caught in the joints 108 and 120 and from being pulled into the guard assembly 22.

It should be understood that, in some other constructions (not shown) and for some aspects of the invention, the guard sections may have a vertical joint which is perpendicular to the channel 92. Also, in some other constructions (not shown) and for some aspects of the invention, the guards 78 and 82 may each be provided by a one-piece guard extending the length of the guard assembly 22.

As shown in FIG. 4, the guard assembly 22 supports the chain assembly 42 and the knife members 46 across the length of the cutting portion P. The guard assembly 22 provides support and guidance to the knife members 46 and to the chain assembly 42 to allow each knife member 46 and the chain assembly 42 to pass from one guard section to the subsequent guard section without interference. The guard assembly 22 and the channel 92 prevent the chain assembly 42 from kinking so that the chain assembly 42 does not lock up. Also, the knife members 46 lead properly into the subsequent guard section to prevent the chain assembly 42 from locking up.

Because, in the illustrated construction and in some aspects of the invention, the guard assembly 22 defines the channel 92 to guide and support the chain assembly 42 and the knife members 46, a special cutter bar (not shown) is not required to use the cutter assembly 18 with an existing cutting apparatus, such as the cutting apparatus 10. Also, because the guard assembly 22 defines the channel 92, the guard assembly 22 is more easily manufactured, and assembly of the cutting apparatus 10 is less difficult.

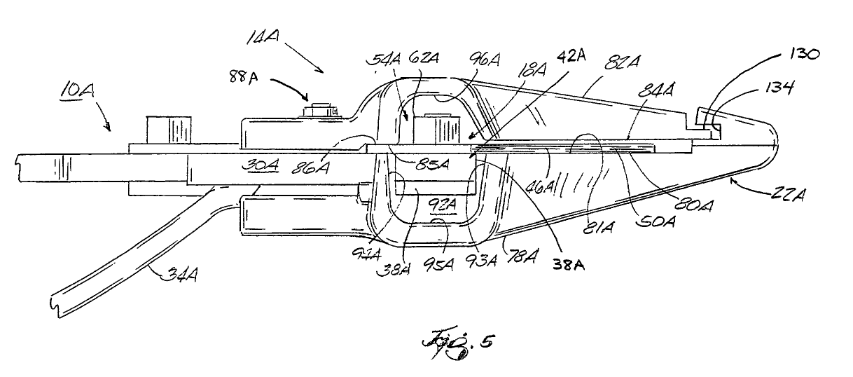

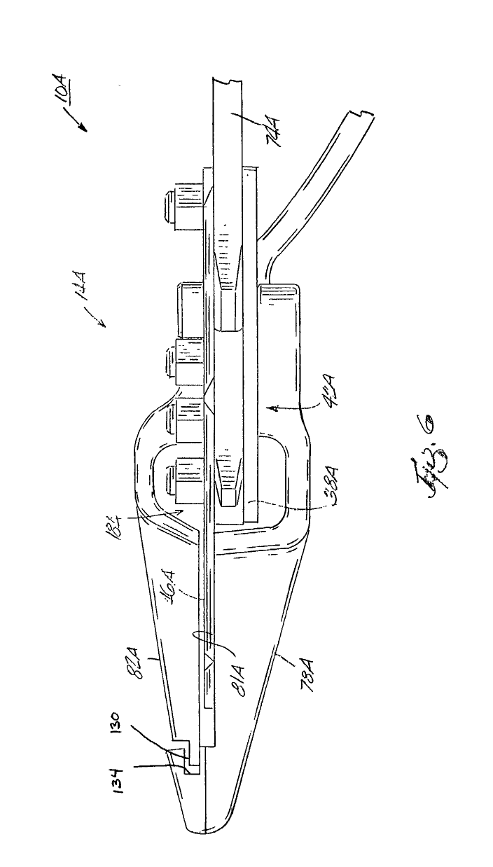

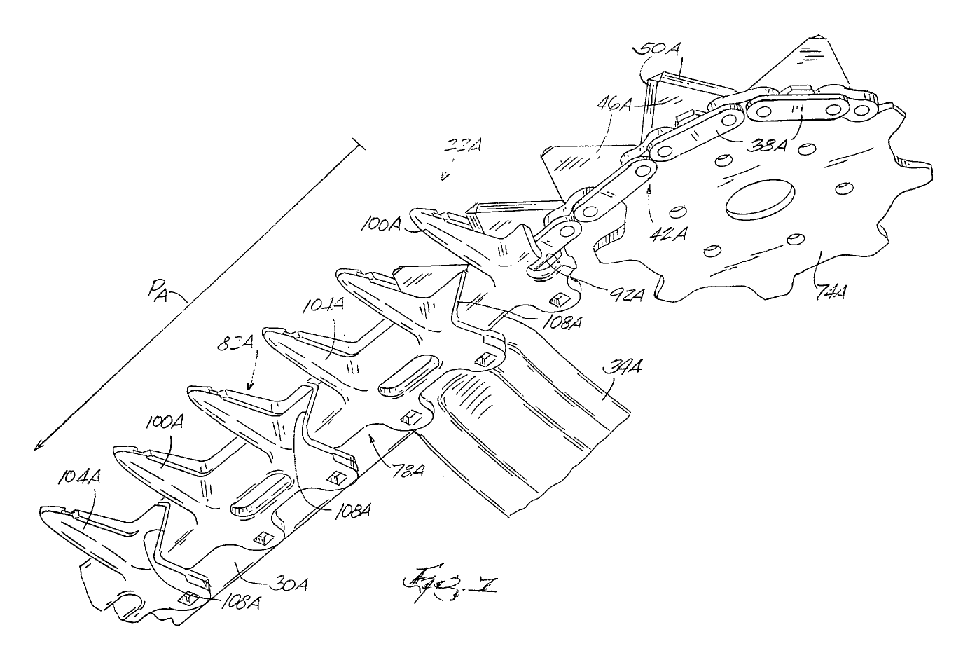

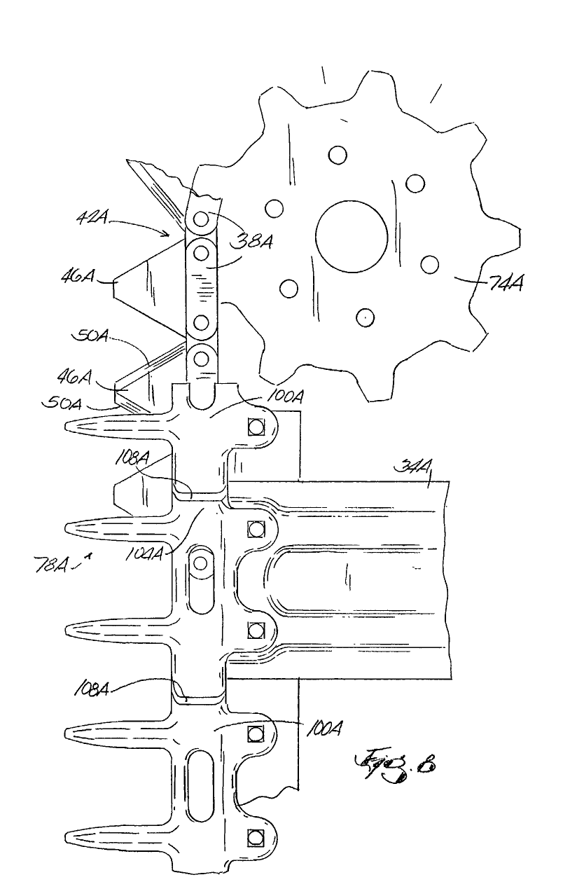

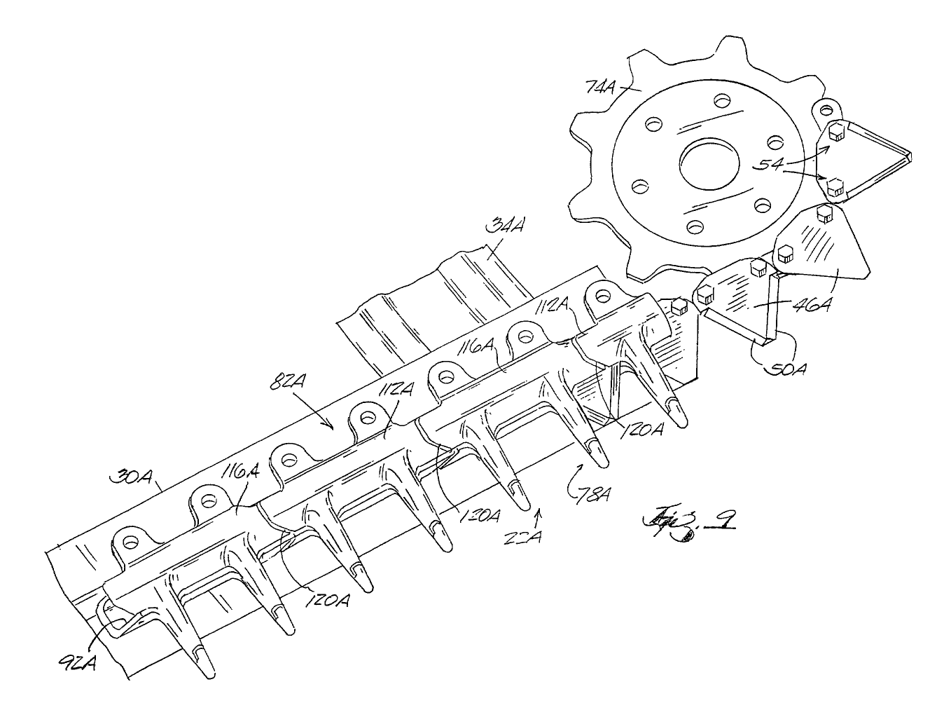

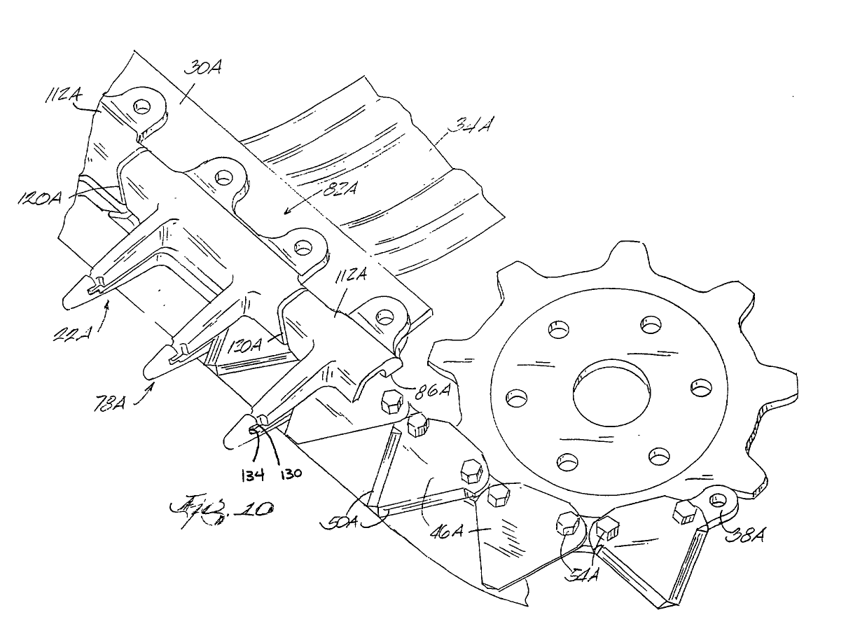

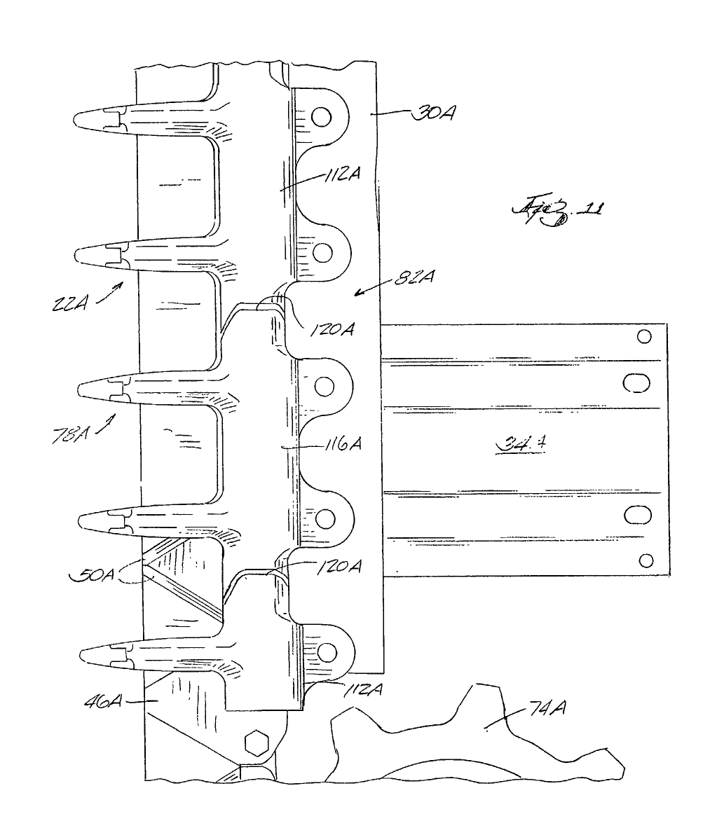

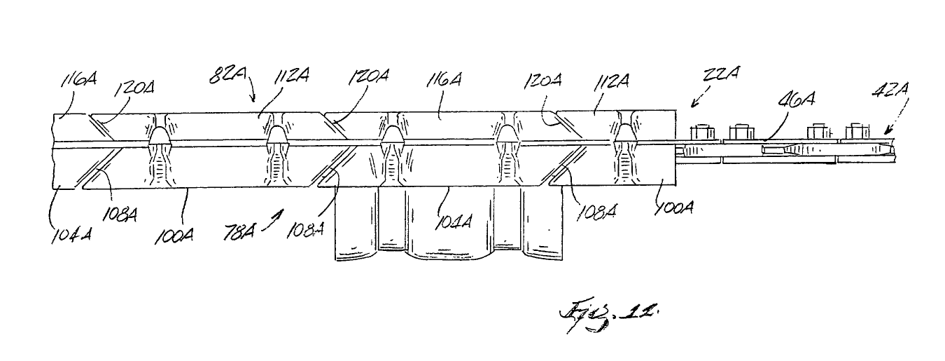

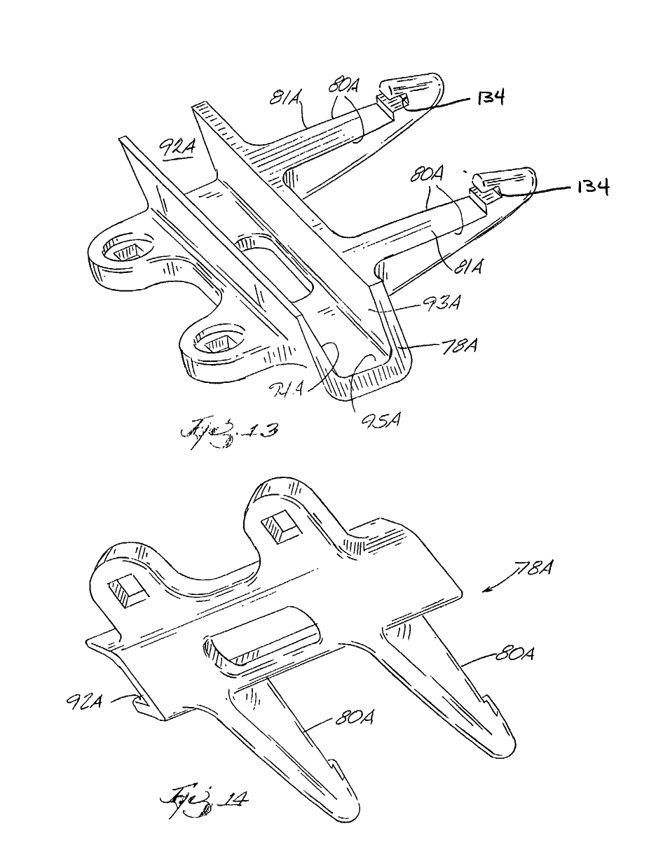

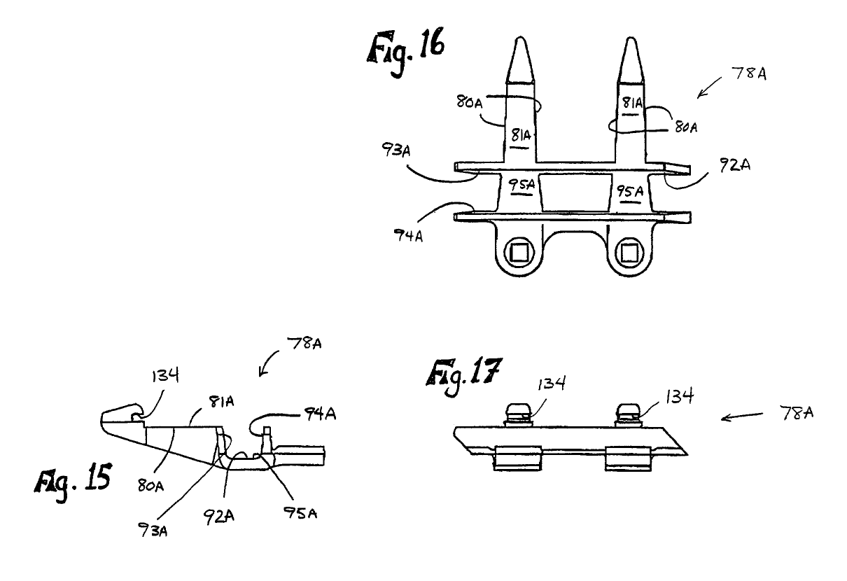

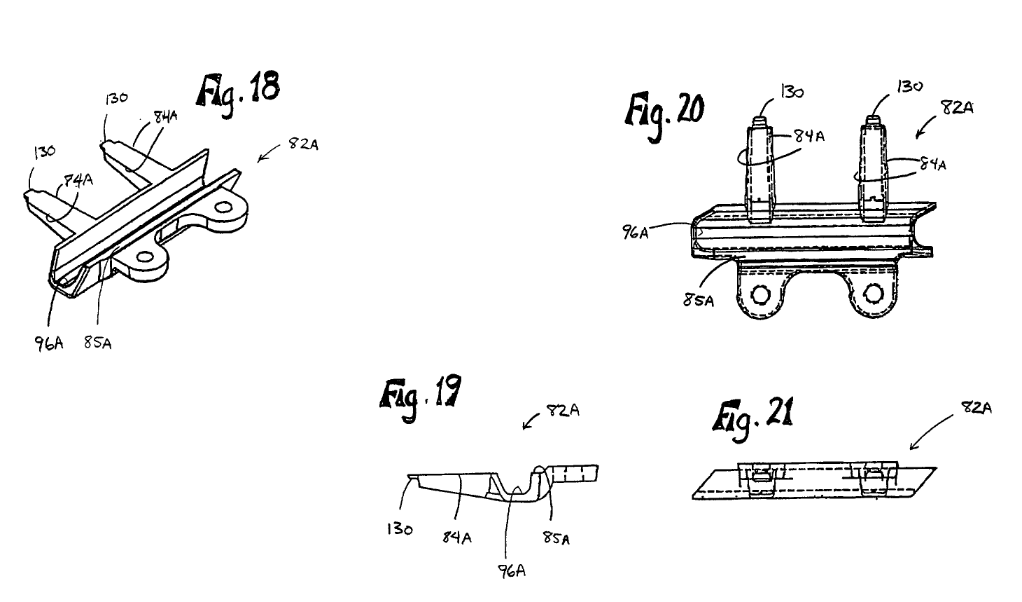

FIGS. 5-21 illustrate a first alternative construction of a cutting apparatus 10A and a guard assembly 22A. Common elements are identified by the same reference number “A”.

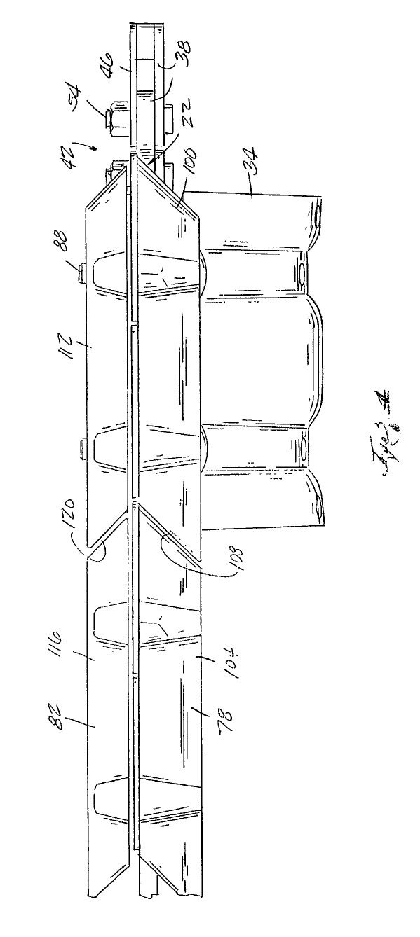

As shown in FIGS. 5-6, the lower guard 78A and the upper guard 82A are connected at their forward ends. The upper guard 82A includes a first connecting member or projection 130 which is engageable with a second connecting member or recess 134 defined by the lower guard 78A.

In this construction, the chain assembly 42A is positioned below the knife members 46A to provide a bottom-chain cutter assembly 18A. In the illustrated construction and in some aspects of the invention, the lower guard 78A defines the channel 92A.

FIG. 22 illustrates a second alternative construction of a cutting apparatus 10B and a guard assembly 22B. Common elements are identified by the same reference number “B”.

The second alternative construction is similar to the construction shown in FIGS. 5-21. As shown in FIG. 22, the lower guard 78B and the upper guard 82B are connected at their forward ends. In this construction, the chain assembly 42B is positioned below the knife members 46B to provide a bottom-chain cutter assembly 18B.

FIG. 23 illustrates a third alternative construction of a cutting apparatus 10C and a guard assembly 22C. Common elements are identified by the same reference number “C”.

As shown in FIG. 23, the chain assembly 42C is positioned above the knife members 46C to provide a top-chain cutter assembly 18C. In the illustrated construction and in some aspects of the invention, the upper guard 82C defines the channel 92C for the chain assembly 42C. In the illustrated construction, the upper guard 82C provides the opposite lateral channel surfaces 93C and 94C and the channel surface 95C extending between the lateral channel surfaces 93C and 94C. Also, the lower guard 78C provides the space or clearance 96C.

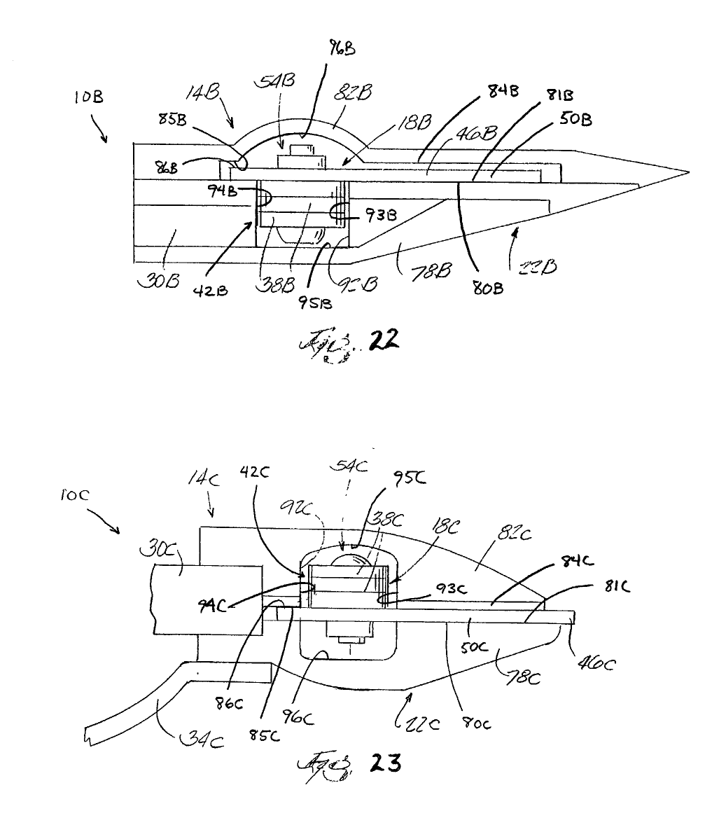

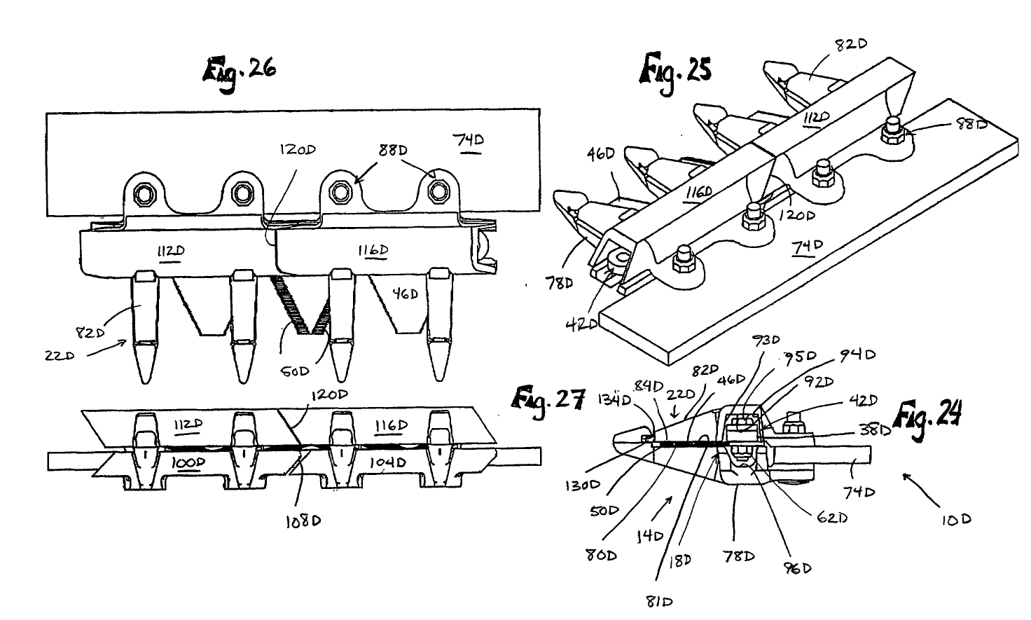

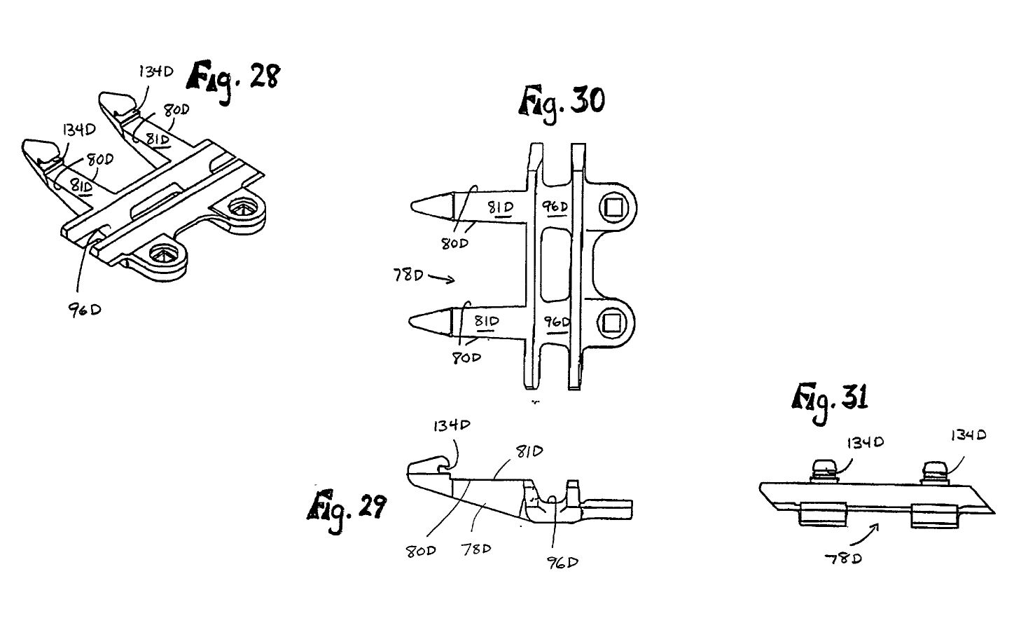

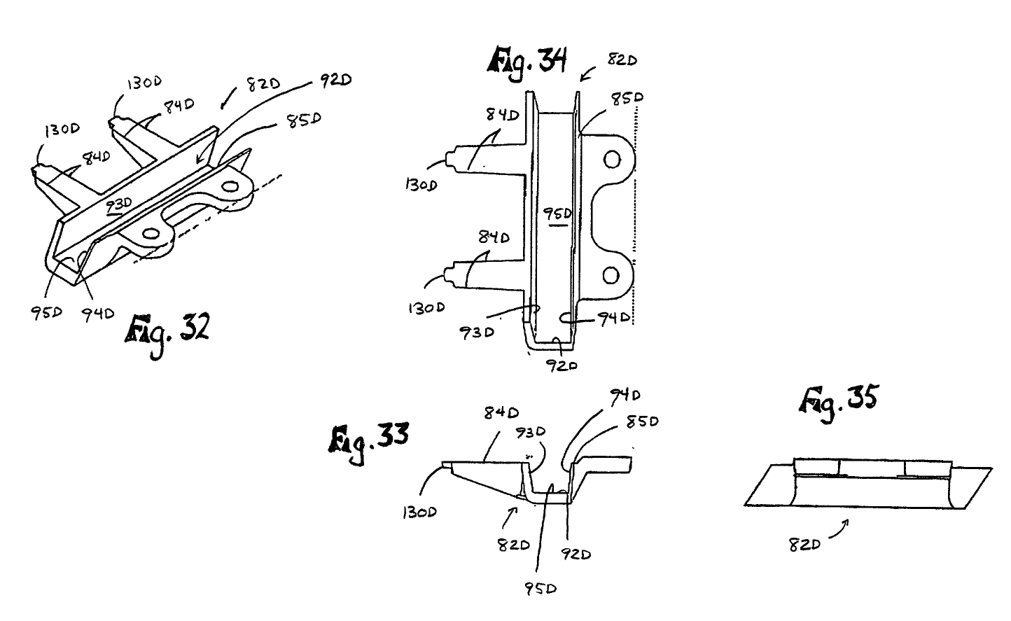

FIGS. 24-35 illustrate a fourth alternative construction of the cutting apparatus 10D and the guard assembly 22D. Common elements are identified by the same reference number “D”.

The fourth alternative construction is similar to the construction shown in FIG. 23. The chain assembly 42D is positioned above the knife members 46D to provide a top-chain cutter assembly 18D. In the illustrated construction and in some aspects of the invention, the upper guard 82D defines the channel 92D for the chain assembly 42D. In the illustrated construction, the upper guard 82D provides the opposite lateral channel surfaces 93D and 94D and the channel surface 95D extending between the lateral channel surfaces 93D and 94D. Also, the lower guard 78D provides the space or clearance 96D.

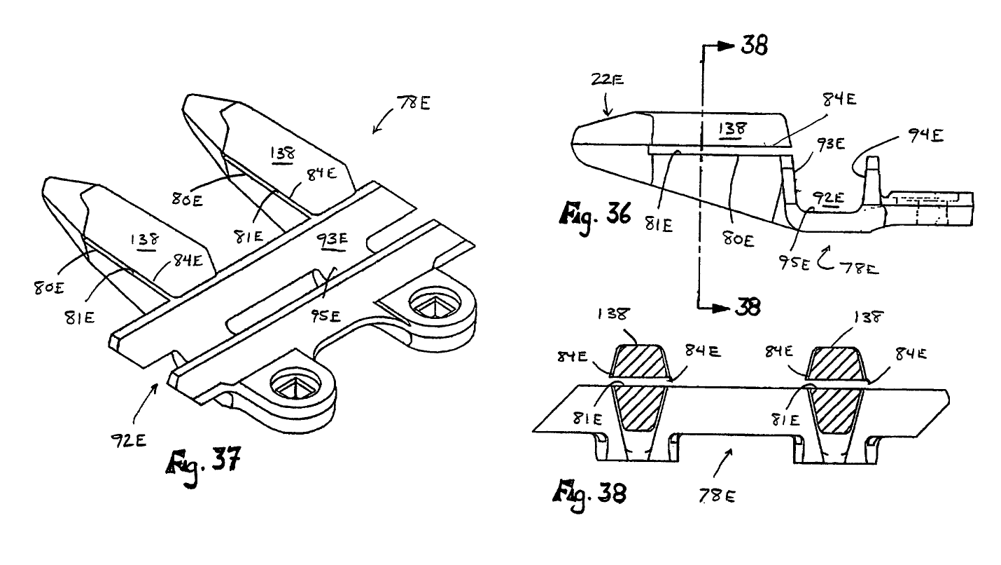

FIGS. 36-38 illustrate a fifth alternative construction of the guard assembly 22E for use with a cutting apparatus (not shown but similar to the cutting apparatus 10 illustrated in FIGS. 1-4). Common elements are identified by the same reference number “E”.

The guard assembly 22E includes a single lower guard 78E for use with a bottom-chain cutter assembly (not shown but similar to the cutter assembly 18 illustrated in FIGS. 1-4). The lower guard 78E includes an upper extension 138 providing the lower guard surface 85E engageable with a portion of the upper surface of the knife members (not shown but similar to the knife members 46 illustrated in FIGS. 1-4) to provide the “hold-down” feature.

In the illustrated construction and in some aspects of the invention, the lower guard 78E defines the channel 92E for the chain assembly (not shown but similar to the chain assembly 42 illustrated in FIGS. 1-4). The lower guard 78E provides the opposite lateral channel surfaces 93E and 94E and the lower channel surface 95E.

One or more of the above-identified and other independent features and independent advantages of the invention are set forth in the following claims:

We claim:

1. A cutting apparatus comprising:
a frame supported for movement over ground, the frame having a forward portion;
a cutter support supported on the forward portion of the frame; and
a cutting assembly including
a chain cutter assembly including
a continuous chain assembly having opposite lateral chain surfaces,
a plurality of knives connected to the chain assembly to form
a cutting portion, and
a drive assembly for driving the chain assembly, and
a guard assembly including a guard supported by the cutter support, the guard defining a channel having opposite lateral channel surfaces engageable with the opposite lateral chain surfaces to guide a portion of the chain assembly in the channel.

2. The apparatus as set forth in claim 1 and further comprising a second cutting assembly selectively supportable by the cutter support and including
a reciprocating cutter assembly including
a cutter bar supported for reciprocating movement,
a plurality of knives supported by the cutter bar, and
a reciprocating drive assembly operable to reciprocate the cutter bar, and
a reciprocating cutter guard assembly including a reciprocating cutter guard member selectively supported by the cutter support,
wherein the first-mentioned cutting assembly is substitutable for the second cutting assembly.

3. The apparatus as set forth in claim 1 wherein each of the plurality of knives has a knife upper surface and a knife lower surface, and wherein the guard assembly includes a first guard positioned adjacent the knife lower surface and a second guard positioned adjacent the knife upper surface, one of the first guard and the second guard defining the channel.

4. The apparatus as set forth in claim 3 wherein the first guard defines the channel.

5. The apparatus as set forth in claim 3 wherein the second guard defines the channel.

6. The apparatus as set forth in claim 1 wherein the channel has a channel surface extending between the opposite lateral channel surfaces.

7. The apparatus as set forth in claim 1 wherein each of the plurality of knives has a knife upper surface and a knife lower surface, and wherein the guard is positioned adjacent the knife lower surface, the guard including a guard upper surface engaging the knife lower surface to support selected ones of the plurality of knives.

8. The apparatus as set forth in claim 7 wherein the cutting portion has a length, and wherein the guard upper surface engages the knife lower surface of the plurality of knives in the cutting portion along the length of the cutting portion.

9. The apparatus as set forth in claim 1 wherein the cutting portion has a length, and wherein the channel extends along the length of the cutting portion.

10. The apparatus as set forth in claim 1 wherein each of the plurality of knives has a knife upper surface and a knife lower surface, and wherein the guard assembly includes a first guard positioned adjacent the knife lower surface and a second guard positioned adjacent the knife upper surface, the second guard having a guard lower surface engageable with a portion of the knife upper surface.

11. The apparatus as set forth in claim 1 wherein the chain cutter includes fastener members extending generally vertically and connecting the plurality of knives to the chain assembly, each fastener member having a fastener end, and wherein the guard has a channel surface extending between the opposite lateral channel surfaces, the channel surface being spaced from the fastener end.

12. The apparatus as set forth in claim 11 wherein the opposite lateral channel surfaces are spaced from the fastener end.

13. The apparatus as set forth in claim 1 wherein the guard assembly includes a first guard section and a second guard section cooperating to define the channel, the first guard section being supported adjacent the second guard section at a joint, the joint being oriented at an angle of 45° relative to the channel and relative to a vertical plane.

14. The apparatus as set forth in claim 1 wherein each of the plurality of knives has a knife upper surface and a knife lower surface, and wherein the guard assembly includes a first guard positioned adjacent the knife lower surface, the first guard including a first lower guard section and a second lower guard section supported adjacent to the first lower guard section at a lower joint, the lower joint being oriented at a non-perpendicular first angle relative to the channel, the guard assembly also including a second guard positioned adjacent the knife upper surface, the second guard including a first upper guard section and a second upper guard section positioned adjacent the first upper guard section at an upper joint, the upper joint being oriented at a non-perpendicular second angle relative to the channel, the second angle being different than the first angle, the upper joint being laterally offset from the lower joint, one of the first guard and the second guard defining the channel.

15. A cutting apparatus comprising:
a frame supported for movement over ground, the frame having a forward portion;
a cutter support supported on the forward portion of the frame; and
a cutting assembly including
a chain cutter assembly including
a continuous chain assembly,
a plurality of knives connected to the chain assembly to form
a cutting portion, and
a drive assembly for driving the chain assembly, and
a guard assembly including a first guard section and a second guard section supported by the cutter support, the first guard section and the second guard section cooperating to support a portion of the chain cutter assembly, the first guard section being supported adjacent the second guard section at a joint, the joint being oriented at a non-perpendicular angle relative to the cutting portion.

16. The apparatus as set forth in claim 15 wherein the joint is oriented at an angle of 45° relative to a vertical plane.

17. The apparatus as set forth in claim 15 wherein each of the plurality of knives has a knife upper surface and a knife lower surface, and wherein the guard assembly includes a first guard positioned adjacent the knife lower surface, the first guard including a first lower guard section and a second lower guard section supported adjacent to the first lower guard section at a lower joint, the lower joint being oriented at a non-perpendicular angle relative to the cutting portion, the guard assembly also including a second guard positioned adjacent the knife upper surface.

18. The apparatus as set forth in claim 17 wherein the second guard includes a first upper guard section and a second upper guard section positioned adjacent the first upper guard section at an upper joint, the upper joint being oriented at a non-perpendicular second angle relative to the cutting portion.

19. The apparatus as set forth in claim 18 wherein the second angle is different than the first-mentioned non-perpendicular angle.

20. The apparatus as set forth in claim 18 wherein the lower joint is laterally offset from the upper joint.

21. The apparatus as set forth in claim 15 wherein the chain assembly has opposite lateral chain surfaces, and wherein the first guard section and the second guard section cooperate to define a channel having opposite lateral channel surfaces engageable with the opposite lateral chain surfaces to guide a portion of the chain assembly in the channel.

22. The apparatus as set forth in claim 21 and further comprising a second cutting assembly selectively supportable by the cutter support and including
a reciprocating cutter assembly including
a cutter bar supported for reciprocating movement,
a plurality of knives supported by the cutter bar, and
a reciprocating drive assembly operable to reciprocate the cutter bar, and
a reciprocating cutter guard assembly including a reciprocating cutter guard member selectively supported by the cutter support,
wherein the first-mentioned cutting assembly is substitutable for the second cutting assembly.

23. The apparatus as set forth in claim 21 wherein each of the plurality of knives has a knife upper surface and a knife lower surface, and wherein the guard assembly includes a first guard positioned adjacent the knife lower surface and a second guard positioned adjacent the knife upper surface, one of the first guard and the second guard defining the channel.

24. The apparatus as set forth in claim 23 wherein the first guard defines the channel.

25. The apparatus as set forth in claim 23 wherein the second guard defines the channel.

26. The apparatus as set forth in claim 21 wherein the cutting portion has a length, and wherein the channel extends along the length of the cutting portion.

27. A guard assembly for a cutting apparatus, the cutting apparatus including a frame supported for movement over ground, the frame having a forward portion, a cutter support supported on the forward portion of the frame, and a chain cutter assembly including a continuous chain assembly having opposite lateral chain surfaces, a plurality of knives connected to the chain assembly to form a cutting portion, and a drive assembly for driving the chain assembly, said guard assembly comprising:
a guard defining a channel having opposite lateral channel surfaces engageable with the opposite lateral chain surfaces to guide a portion of the chain assembly in the channel; and
a fastener selectively fastening the guard to the cutter support.

28. The guard assembly as set forth in claim 27 wherein each of the plurality of knives has a knife upper surface and a knife lower surface, and wherein said guard assembly comprises:
a first guard positionable adjacent the knife lower surface; and
a second guard positionable adjacent the knife upper surface, one of the first guard and the second guard defining the channel.

29. The guard assembly as set forth in claim 28 wherein the first guard defines the channel.

30. The guard assembly as set forth in claim 28 wherein the second guard defines the channel.

31. The guard assembly as set forth in claim 27 wherein the channel has a channel surface extending between the opposite lateral channel surfaces.

32. The guard assembly as set forth in claim 27 wherein each of the plurality of knives has a knife upper surface and a knife lower surface, and wherein the guard is positionable adjacent the knife lower surface, the guard including a guard upper surface engageable with the knife lower surface to support selected ones of the plurality of knives.

33. The guard assembly as set forth in claim 32 wherein the cutting portion has a length, and wherein the guard upper surface is engageable with the knife lower surface of the plurality of knives in the cutting portion along the length of the cutting portion.

34. The guard assembly as set forth in claim 27 wherein the cutting portion has a length, and wherein the channel extends along the length of the cutting portion.

35. The guard assembly as set forth in claim 27 wherein the chain cutter includes fastener members extending generally vertically and connecting the plurality of knives to the chain assembly, each fastener member having a fastener end, and wherein the guard has a channel surface extending between the opposite lateral channel surfaces, the channel surface being spaced from the fastener end.

36. The guard assembly as set forth in claim 35 wherein the opposite lateral channel surfaces are spaced from the fastener end.

37. The guard assembly as set forth in claim 27 wherein each of the plurality of knives has a knife upper surface and a knife lower surface, and wherein said guard assembly comprises:
a first guard positionable adjacent the knife lower surface; and
a second guard positionable adjacent the knife upper surface, the second guard having a guard lower surface engageable with a portion of the knife upper surface.

38. The guard assembly as set forth in claim 27 wherein the guard includes a first guard section and a second guard section cooperating to define the channel, the first guard section being supported adjacent the second guard section at a joint, the joint being oriented at an angle of 45° relative to the channel and relative to a vertical plane.

39. The guard assembly as set forth in claim 27 wherein each of the plurality of knives has a knife upper surface and a knife lower surface, and wherein the guard assembly includes a first guard positioned adjacent the knife lower surface, the first guard including a first lower guard section and a second lower guard section supported adjacent to the first lower guard section at a lower joint, the lower joint being oriented at a non-perpendicular first angle relative to the channel, the guard assembly also including a second guard positioned adjacent the knife upper surface, the second guard including a first upper guard section and a second upper guard section positioned adjacent the first upper guard section at an upper joint, the upper joint being oriented at a non-perpendicular second angle relative to the channel, the second angle being different than the first angle, the upper joint being laterally offset from the lower joint, one of the first guard and the second guard defining the channel.

40. A guard assembly for a cutting apparatus, the cutting apparatus including a frame supported for movement over ground, the frame having a forward portion, a cutter support supported on the forward portion of the frame, and a chain cutter assembly including a continuous chain assembly, a plurality of knives connected to the chain assembly to form a cutting portion, and a drive assembly for driving the chain assembly, said guard assembly comprising:
a first guard section supportable by the cutter support; and
a second guard section supportable by the cutter support, the first guard section and the second guard section cooperating to support a portion of the chain cutter assembly, the first guard section being supported adjacent the second guard section at a joint, the joint being oriented at a non-perpendicular angle relative to the channel.

41. The guard assembly as set forth in claim 40 wherein the joint is oriented at an angle of 45° relative to a vertical plane.

42. The guard assembly as set forth in claim 40 wherein each of the plurality of knives has a knife upper surface and a knife lower surface, and wherein the guard assembly includes a first guard positioned adjacent the knife lower surface, the first guard including a first lower guard section and a second lower guard section supported adjacent to the first lower guard section at a lower joint, the lower joint being oriented at a non-perpendicular angle relative to the cutting portion, the guard assembly also including a second guard positioned adjacent the knife upper surface.

43. The guard assembly as set forth in claim 42 wherein the second guard includes a first upper guard section and a second upper guard section positioned adjacent the first upper guard section at an upper joint, the upper joint being oriented at a non-perpendicular second angle relative to the cutting portion.

44. The guard assembly as set forth in claim 43 wherein the second angle is different than the first-mentioned non-perpendicular angle.

45. The guard assembly as set forth in claim 43 wherein the lower joint is laterally offset from the upper joint.

46. The guard assembly as set forth in claim 40 wherein the chain assembly has opposite lateral chain surfaces, and wherein the first guard section and the second guard section cooperate to define a channel having opposite lateral channel surfaces engageable with the opposite lateral chain surfaces to guide a portion of the chain assembly in the channel.

47. The guard assembly as set forth in claim 46 wherein each of the plurality of knives has a knife upper surface and a knife lower surface, and wherein said guard assembly comprises:
a first guard positionable adjacent the knife lower surface; and
a second guard positionable adjacent the knife upper surface, one of the first guard and the second guard defining the channel.

48. The guard assembly as set forth in claim 47 wherein the first guard defines the channel.

49. The guard assembly as set forth in claim 47 wherein the second guard defines the channel.

50. The guard assembly as set forth in claim 46 wherein the cutting portion has a length, and wherein the channel extends along the length of the cutting portion.

51. A guard assembly for a cutting apparatus, the cutting apparatus including a frame supported for movement over ground, the frame having a forward portion, a cutter support supported on the forward portion of the frame, and a chain cutter assembly including a continuous chain assembly having opposite lateral chain surfaces, a plurality of knives connected to the chain assembly to form a cutting portion, and a drive assembly for rotatably driving the chain assembly, said guard assembly comprising:
a first guard section supportable by the cutter support; and
a second guard section supportable by the cutter support, the first guard section and the second guard section cooperating to define a channel having opposite lateral channel surfaces engageable with the opposite lateral chain surfaces to guide a portion of the chain assembly in the channel, the first guard section being supported adjacent the second guard section at a joint, the joint being oriented at an angle of 45° relative to the channel and relative to a vertical plane.

52. The guard assembly as set forth in claim 51 wherein each of the plurality of knives has a knife upper surface and a knife lower surface, and wherein the guard assembly includes a first guard positioned adjacent one of the knife upper surface and the knife lower surface, the first guard including the first guard section and the second guard section supported adjacent to the first guard section at the first-mentioned joint, the guard assembly also including and a second guard positioned adjacent the other of the knife upper surface and the knife lower surface, the second guard including a first second guard section and a second second guard section positioned adjacent the first second guard section at a second joint, the second joint being oriented at a non-perpendicular second angle relative to the channel, the second angle being different than the angle of the first-mentioned joint, the second joint being laterally offset from the first-mentioned joint.

53. A method for assembling a cutting apparatus, said method comprising the acts of:
providing a frame supported for movement over ground, the frame having a forward portion, and a cutter support supported on the forward portion of the frame;
providing a chain cutter assembly including a continuous chain assembly having opposite lateral chain surfaces, a plurality of knives connected to the chain assembly to form a cutting portion, and a drive assembly for driving the chain assembly;
providing a guard assembly including a guard defining a channel having opposite lateral channel surfaces;
supporting the guard on the cutter support; and
supporting a portion of the chain assembly with the guard such that the opposite lateral channel surfaces engage the opposite lateral chain surfaces of the portion of the chain assembly to guide the portion of the chain assembly in the channel.

54. The method as set forth in claim 53 wherein the act of providing a guard assembly includes the act of providing a guard assembly including a first guard section and a second guard section cooperating to define a channel having opposite lateral channel surfaces, and wherein the act of supporting the guard includes the act of supporting the first guard section and the second guard section on the cutter support, the first guard section being supported adjacent the second guard section at a joint, the joint being oriented at an angle of 45° relative to the channel and relative to a vertical plane.

55. The method as set forth in claim 53 wherein each of the plurality of knives has a knife upper surface and a knife lower surface, wherein the act of providing a guard assembly includes
providing a first guard positioned adjacent one of the knife upper surface and the knife lower surface, the first guard including a first first guard section and a second first guard section supported adjacent to the first first guard section at a first joint, the first joint being oriented at a non-perpendicular first angle relative to the channel, and
providing a second guard positioned adjacent the other of the knife upper surface and the knife lower surface, the second guard including a first second guard section and a second second guard section positioned adjacent the first second guard section at a second joint, the second joint being oriented at a non-perpendicular second angle relative to the channel, the second angle being different than the first angle, the second joint being laterally offset from the first joint, one of the first guard and the second guard defining the channel.

56. A method for assembling a cutting apparatus, said method comprising the acts of:
providing a frame supported for movement over ground, the frame having a forward portion, and a cutter support supported on the forward portion of the frame;
providing a chain cutter assembly including a continuous chain assembly, a plurality of knives connected to the chain assembly to form a cutting portion, and a drive assembly for driving the chain assembly;
providing a guard assembly including a first guard section and a second guard section; and
supporting the first guard section and the second guard section on the cutter support, the first guard section being supported adjacent the second guard section at a joint;
supporting a portion of the chain cutter assembly with the guard assembly, the joint being oriented at a non-perpendicular angle relative to the cutting portion.

57. The method as set forth in claim 56 wherein, in the act of supporting the first guard section and the second guard section, the joint is oriented at an angle of 45° relative to a vertical plane.

58. The method as set forth in claim 56 wherein each of the plurality of knives has a knife upper surface and a knife lower surface, and wherein the act of providing a guard assembly includes
providing a first guard positioned adjacent one of the knife upper surface and the knife lower surface, the first guard including the first guard section and the second guard section supported adjacent to the first guard section at the first-mentioned joint, and
providing a second guard positioned adjacent the other of the knife upper surface and the knife lower surface, the second guard including a first second guard section and a second second guard section positioned adjacent the first second guard section at a second joint, the second joint being oriented at a non-perpendicular second angle relative to the channel, the second angle being different than the angle of the first-mentioned joint, the second joint being laterally offset from the first-mentioned joint.
